(19) United States
(12) Patent Application Publication
(10) Pub. No.: US 2009/0050418 A1
(43) Pub. Date: Feb. 26, 2009

(54) System and Method for Monitoring Brake Wear

(76) Inventors: Victor Vargas, Lafayette, IN (US); Rodney P. Ehrlich, Monticello, IN (US); Paul D. Nelson, Martinsville, IN (US)

Correspondence Address: BARNES & THORNBURG LLP, 11 SOUTH MERIDIAN, INDIANAPOLIS, IN, 46204, US

(21) Appl. No.: 11/844,871

(22) Filed: Aug. 24, 2007

(51) Int. Cl. F16D 66/02

(52) U.S. Cl. 188/1.11 L

(57) ABSTRACT

A system and method are provided for monitoring brake wear of a brake assembly. A cam shaft may be coupled to a brake assembly and configured such that movement of the cam shaft engages and disengages the brake assembly, a cam shaft movement sensor produces a signal corresponding to a position of the cam shaft, and a control circuit assigns the signal produced by the cam shaft movement sensor at an unadjusted and unengaged position of the brake assembly to a reference cam shaft position, thereafter monitors the signal to determine an engaged cam shaft position when the brake assembly is engaged, and activates at least one indicator if the engaged cam shaft position exceeds a threshold cam shaft position stored in the memory unit. The threshold cam shaft position is based on the reference position and is a cam shaft position beyond which the brake assembly is worn.

### FIELD OF THE INVENTION

The present invention relates generally to transportation vehicle monitoring systems, and more specifically to systems and methods for monitoring brake wear in brake assemblies associated with one or more wheels of a transportation vehicle.

### BACKGROUND

One or more components of conventional brake assemblies for transportation vehicles wear through repeated use. It is desirable to monitor such brake wear in brake assemblies associated with one or more wheels of a transportation vehicle.

### SUMMARY

The present invention may comprise one or more of the features recited in the attached claims, and/or one or more of the following features and combinations thereof. A system for monitoring brake wear in a wheel of a transportation vehicle may comprise a brake assembly coupled to the wheel, and a cam shaft coupled to the brake assembly. The cam shaft may be configured such that movement of the cam shaft engages and disengages the brake assembly. A cam shaft movement sensor may be configured to produce a signal corresponding to a position of the cam shaft, and the system may include at least one indicator. A control circuit may include a memory having instructions stored therein that are executable by the control circuit to assign the signal produced by the cam shaft movement sensor at an unadjusted and unengaged position of the brake assembly to a reference cam shaft position, to thereafter monitor the signal to determine an engaged cam shaft position when the brake assembly is engaged, and to activate the at least one indicator if the engaged cam shaft position exceeds a threshold cam shaft position stored in the memory unit. The threshold cam shaft position may be predetermined relative to the reference cam shaft position prior to storage in the memory unit, and may be a cam shaft position beyond which the brake assembly is worn.

The brake assembly may comprise at least one brake lining mounted to at least one brake shoe within a brake drum. The unadjusted and unengaged position of the brake assembly may correspond to an unengaged position of the brake when the at least one brake lining is initially installed on the at least one brake shoe. The brake assembly may be engaged when the at least one brake lining is forced by the cam shaft against an inner surface of the brake drum. The cam shaft position beyond which the brake assembly is worn may be selected to be a cam shaft position beyond which the at least one brake lining is worn.

In on embodiment, the cam shaft may be configured such that rotation of the cam shaft engages and disengages the brake assembly. The cam shaft movement sensor may be configured to produce a signal corresponding to an angle of the cam shaft. The instructions stored in the memory may be executable by the control circuit to assign the signal produced by the cam shaft movement sensor at the unadjusted and unengaged position of the brake assembly to a reference cam shaft angle, to thereafter monitor the signal to determine an engaged cam shaft angle when the brake assembly is engaged and to activate the at least one indicator if the engaged cam shaft angle exceeds a threshold cam shaft angle stored in the memory unit. The threshold cam shaft angle may be a cam shaft angle above which the brake assembly is worn. The reference cam shaft angle may be selected to be a fixed cam shaft angle of zero degrees. Alternatively, the reference cam shaft angle may be selected to be a fixed, non-zero cam shaft angle. In an alternative embodiment, the cam shaft may be configured such that linear translation of the cam shaft engages and disengages the brake assembly. The cam shaft movement sensor may be configured to produce a signal corresponding to linear movement of the cam shaft. The instructions stored in the memory may be executable by the control circuit to assign the signal produced by the cam shaft movement sensor at the unadjusted and unengaged position of the brake assembly to a reference cam shaft position, to thereafter monitor the signal to determine an engaged cam shaft position when the brake assembly is engaged and to activate the at least one indicator if the engaged cam shaft position exceeds a threshold cam shaft position stored in the memory unit. The threshold cam shaft position may be a cam shaft position beyond which the brake assembly is worn.

The brake assembly may comprise at least one brake lining mounted to at least one brake shoe within a brake drum and a slack adjuster that is responsive to adjustment thereof to bring the at least one brake lining closer to the brake drum. The unadjusted and unengaged position of the brake assembly may correspond to an unengaged position of the brake when the slack adjuster is in an unadjusted position prior to any adjustment thereof. The brake assembly may be engaged when the at least one brake lining is forced by the cam shaft against an inner surface of the brake drum. The cam shaft position beyond which the brake assembly is worn may be selected to be a cam shaft position beyond which the at least one brake lining is worn. In one embodiment, the system may further comprise a brake shoe actuator mounted to one end of the cam shaft. The brake shoe actuator may have at least one convex surface and at least one concave surface. The cam shaft may be configured such that rotation of the cam shaft causes the at least one convex surface of the brake shoe actuator to engage the at least one brake shoe and move the brake assembly between engaged and disengaged positions. The unadjusted and unengaged position of the brake assembly may correspond to a position of the cam shaft when the at least one concave surface of the brake shoe actuator engages the at least one brake shoe. The cam shaft movement sensor may be configured to produce a signal corresponding to an angle of the cam shaft. The instructions stored in the memory may be executable by the control circuit to assign the signal produced by the cam shaft movement sensor at the unadjusted and unengaged position of the brake assembly to a reference cam shaft angle, to thereafter monitor the signal to determine an engaged cam shaft angle when the brake assembly is engaged and to activate the at least one indicator if the engaged cam shaft angle exceeds a threshold cam shaft angle stored in the memory unit. The threshold cam shaft angle may be a cam shaft angle above which the brake assembly is worn. The reference cam shaft angle may be selected to be a fixed cam shaft angle of zero degrees. Alternatively, the reference cam shaft angle may be selected to be a fixed, non-zero cam shaft angle. In an alternative embodiment, the cam shaft may be configured such that linear translation of the cam shaft engages and disengages the brake assembly. The cam shaft movement sensor may be configured to produce a signal corresponding to linear movement of the cam shaft. The instructions stored in the memory may be executable by the control circuit to assign the signal produced by the cam shaft movement sensor at the unadjusted and unengaged position of the brake assembly to a reference cam shaft position, to thereafter monitor the signal to determine an engaged cam shaft position when the brake assembly is engaged and to activate the at least one indicator if the engaged cam shaft position exceeds a threshold cam shaft position stored in the memory unit. The threshold cam shaft position may be a cam shaft position beyond which the brake assembly is worn.

The system may further comprise a magnetic component mounted to one end of the cam shaft. The cam shaft movement sensor may comprise a magnetic sensor. The cam shaft movement sensor may comprise a magnetic sensor positioned relative to the magnetic component such that the magnetic sensor does not physically contact the magnetic component. The magnetic component may comprise a magnetic surface having a portion that is formed of a magnetic north material and a separate portion that is formed of a magnetic south material. The portion of the magnetic surface that is formed of a magnetic north material may comprise about 50% of the magnet, and the separate portion of the magnet that is formed of a magnetic south material may comprise about another 50% of the magnet. Opposing edges of the north and south materials of the magnetic surface may be planar. The magnetic component may be circular in cross-section.

The magnetic sensor may be a wireless sensor configured to transmit the signal wirelessly. The control circuit may comprise a wireless signal receiving circuit configured to receive the signal wirelessly transmitted by the magnetic sensor. Alternatively, the system may further comprise a physical signal communication path electrically connected between the magnetic sensor and the control circuit.

The at least one indicator may comprise at least one visual indicator. Alternatively or additionally, the at least one indicator may comprise at least one audible indicator. The at least one indicator may be located in a cab area of the vehicle.

The transportation vehicle may include a plurality of wheels and a corresponding plurality of brake assemblies each coupled to a different one of the plurality of wheels. The instructions stored in the memory include instructions that are executable by the control circuit to control the at least one indicator to provide notification when at least one of the plurality of brake assemblies is worn and to further identify which one or more of the brake assemblies is worn. The at least one indicator may be located in a cab area of the vehicle.

The vehicle may comprise a towing vehicle and a towed vehicle that is towed by the towing vehicle. The at least one indicator is located in a cab area of the towing vehicle. Alternatively or additionally, the at least one indicator comprises at least one indicator located in the cab area of the vehicle and at least one indicator mounted to or carried by the towed vehicle. The at least one indicator located in the cab area of the vehicle may be controlled only to provide notification when at least one of the plurality of brake assemblies is worn. The at least one indicator carried by or mounted to the towed vehicle may be controlled to identify which one or more of the brake assemblies is worn. Alternatively or additionally, the at least one indicator may comprise at least a first visual indicator mounted to or carried by the towed vehicle and at least a second visual indicator mounted to or carried by the towed vehicle at a location that is visible by an occupant of the towing vehicle. The at least a second visual indicator may be controlled only to provide visual notification when at least one of the plurality of brake assemblies is worn. The at least a first visual indicator may be controlled to identify which one or more of the brake assemblies is worn. The towing vehicle may be a tractor truck and the towed vehicle may comprise at least one trailer.

The brake assembly may comprise at least one brake lining mounted to at least one brake shoe within a brake drum. The system may further comprise an actuator mounted between the cam shaft and the at least one brake shoe. The actuator may be configured to be responsive to movement of the cam shaft to engage and disengage the brake assembly by moving the at least one brake shoe to correspondingly engage and disengage the at least one brake lining with an inner surface of the brake drum. The actuator may be a rotatable actuator configured to be responsive to rotation of the cam shaft to rotatably engage the at least one brake shoe to engage and disengage the at least one brake lining with the inner surface of the brake drum. Alternatively, the actuator may be a linear actuator configured to be responsive to rotation or linear movement of the cam shaft to linearly engage the at least one brake shoe to engage and disengage the at least one brake lining with the inner surface of the brake drum.

A method of monitoring brake wear of a brake assembly associated with a wheel of a transportation vehicle is provided. The brake assembly may have at least one brake lining coupled to a cam shaft that is configured to such that movement of the cam shaft engages and disengages the brake assembly, and a cam shaft movement sensor that is configured to produce a signal corresponding to a position of the cam shaft. The method may comprise assigning the signal produced by the cam shaft movement sensor at an unadjusted and unengaged position of the brake assembly to a reference cam shaft position, monitoring the signal produced by the cam shaft movement sensor and determining a cam shaft position corresponding thereto when the brake assembly is engaged, and activating at least one indicator if the cam shaft position exceeds a threshold cam shaft position that was predetermined relative to the reference cam shaft position and stored in a memory unit. The threshold cam shaft position may correspond to a cam shaft position beyond which the at least one brake lining is worn.

A system for monitoring brake wear in a plurality of wheels of a transportation vehicle comprising a towing vehicle and a towed vehicle that is towed by the towing vehicle. The system may comprise a plurality of brake assemblies each coupled to a different one of the plurality of wheels, a plurality of cam shafts each coupled to a different one of the plurality of brake assemblies and configured such that movement of the cam shaft engages and disengages the corresponding brake assembly, a plurality of cam shaft movement sensors each configured to produce a signal corresponding to a position of a different one of the plurality of cam shafts, at least a first visual indicator carried by or mounted to the towed vehicle, at least a second visual indicator carried by or mounted to the towed vehicle at a location that is visible by an occupant of the towing vehicle, and a control circuit. The control circuit may include a memory having instructions stored therein that are executable by the control circuit to monitor the signals produced by the plurality of cam shaft movement sensors and to control operation of the at least a second visual indicator to provide visual notification when one or more of the plurality of brake assemblies is worn, and to control operation of the at least a first visual indicator to identify which one or more of the plurality of brake assemblies is worn. The towing vehicle may be a tractor truck and the towed vehicle comprises at least one trailer.

A system for monitoring brake wear in a plurality of wheels of a transportation vehicle comprising a towing vehicle and a towed vehicle that is towed by the towing vehicle. The system may comprise a plurality of brake assemblies each coupled to a different one of the plurality of wheels, a plurality of cam shafts each coupled to a different one of the plurality of brake assemblies and configured such that movement of the cam shaft engages and disengages the corresponding brake assembly, a plurality of cam shaft movement sensors each configured to produce a signal corresponding to a position of a different one of the plurality of cam shafts, at least a first visual indicator carried by the towing vehicle, at least a second visual indicator carried by or mounted to the towed vehicle, and a control circuit. The control circuit may include a memory having instructions stored therein that are executable by the control circuit to monitor the signals produced by the plurality of cam shaft movement sensors and to control operation of the at least a first visual indicator to provide visual notification when one or more of the plurality of brake assemblies is worn, and to control operation of the at least a second visual indicator to identify which one or more of the plurality of brake assemblies is worn. The towing vehicle may be a tractor truck and the towed vehicle comprises at least one trailer.

### BRIEF DESCRIPTION OF THE DRAWINGS

FIG. 1 is a side elevational view of one illustrative embodiment of a system for monitoring brake wear in a brake assembly associated with a wheel of a transportation vehicle.

FIG. 2 is an end elevational view of one illustrative embodiment of some of the components forming the brake assembly, shown in an unengaged brake position.

FIG. 3 is an end elevational view of the embodiment illustrated in FIG. 2, shown in an engaged brake position.

FIG. 4 is an end elevational view of one illustrative embodiment of a magnetic component mounted to one end of the brake cam shaft.

FIG. 5 is a block diagram of one illustrative embodiment of the monitoring module of FIG. 1.

FIG. 6A is a block diagram of another illustrative embodiment of the monitoring module of FIG. 1.

FIG. 6B is a block diagram showing further details of one illustrative embodiment of the monitoring module of FIG. 6A.

FIG. 7 is a block diagram of yet another illustrative embodiment of the monitoring module of FIG. 1.

FIG. 8 is a flowchart of one illustrative embodiment of a process, which may be provided in the form of software code executable by the monitoring module of FIG. 1 and any of FIGS. 5-7, for monitoring brake wear.

FIG. 9 is an end elevational view of one illustrative embodiment of some of the components forming the brake assembly of FIGS. 2 and 3, shown in an unadjusted and unengaged brake position.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

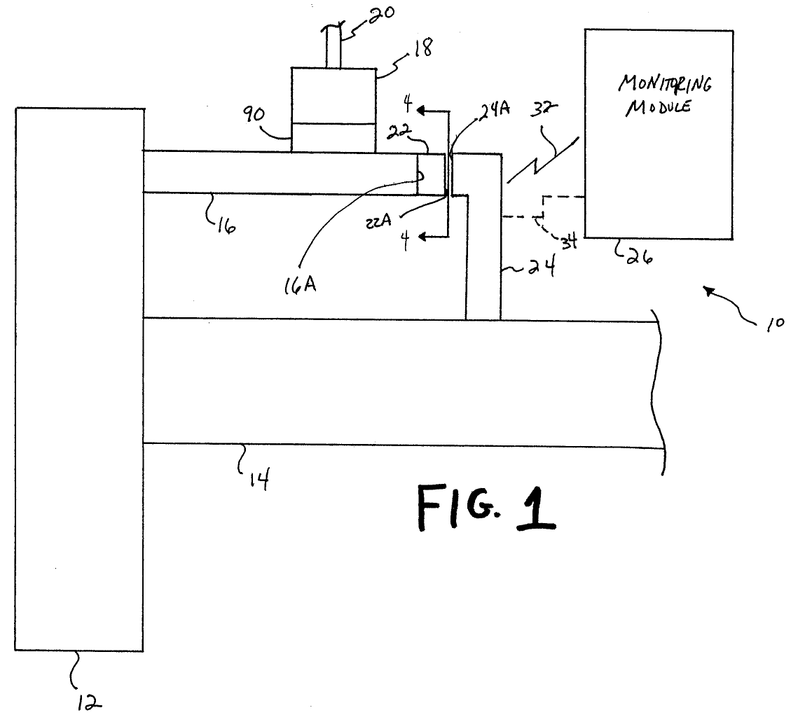

Referring to FIG. 1, a system 10 for monitoring brake wear in at least one wheel 12 of a transportation vehicle is shown. The transportation vehicle may be any vehicle having one or more wheels and that is configured to carry one or more occupants and/or cargo. Examples of such a transportation vehicle includes, but is not limited to, any one or more of a motor vehicle, i.e., a vehicle carrying an internal combustion engine, a vehicle carrying a power plant other than, or in addition to, an internal combustion engine, e.g., a battery operated vehicle, a so-called hybrid vehicle including an internal combustion engine and an alternate power plant such as one or more batteries or other power cells, or the like, a vehicle propelled by an external power plant, a vehicle towed by another vehicle, a train, tram or other rail-based vehicle, or the like. In the illustrated embodiment, the wheel 12 is coupled to, and is rotatably driven by, a conventional vehicle axel 14. A conventional brake is carried by the wheel 12. One end 16A of a conventional cam shaft 16 extends outwardly from the wheel 12 and has a magnetic component 22 affixed thereto. The opposite end 16B of the cam shaft 16 is configured to engage and disengage the brake in a conventional manner.

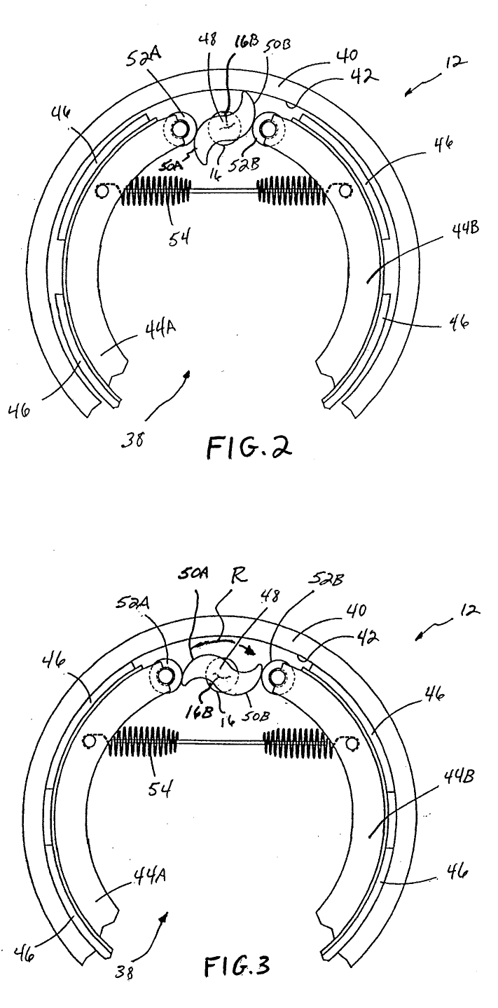

Referring now to FIGS. 2 and 3, details are shown of one illustrative embodiment of the brake assembly 38, carried by the vehicle wheel 12, in an unengaged brake position and in an engaged brake position respectively. In the illustrated embodiment, the wheel 12 includes a brake drum 40 having an inner brake drum surface 42. A pair of brake shoes 44A and 44B are positioned adjacent to the brake drum 40, and a number of brake linings 46 are affixed to each of the brake shoes 44A and 44B such that the brake linings 46 are positioned between the brake shoes 44A, 44B and the inner brake drum surface 42. The opposite end 16B of the cam shaft 16 is mounted or otherwise coupled to a brake shoe actuator that is illustratively shown in the form of a conventional S-cam 48. A wheel or roller 52A is rotatably mounted to the brake shoe 44A, and a wheel or roller 52B is rotatably mounted to the brake shoe 44B. The wheel or roller 52A is biased against one convex surface 50A of the S-cam 48, and the wheel or roller 52B is biased against another convex surface 50B of the S-cam 48, via a spring 54 that extends between the brake shoes 44A and 44B.

Normally, when the brake assembly 38 is in the unengaged brake position illustrated in FIG. 2, the spring 54 biases the brake shoes 44A and 44B toward each other so that the brake linings 46 are drawn away from the inner brake drum surface 42. When the cam shaft 16 rotates in the direction “R”, as illustrated in FIG. 3, the rotating outer surfaces 50A and 50B of the S-cam 48 act upon the wheels or rollers 52A and 52B respectively to force the brake shoes 44A and 44B outwardly against the biasing force of the spring 54 to forcibly engage the brake linings 46 against the inner brake drum surface 42. The position of the brake assembly 38 illustrated in FIG. 3 is the engaged brake position. When the cam shaft 16 then rotates in a direction opposite to the direction “R,” the rotating outer surfaces 50A and 50B of the S-cam 48 allow the brake shoes 44A and 44B to return, under the bias of the spring 54, to the unengaged brake position illustrated in FIG. 2. It will be understood that the structure and operation of the brake assembly embodiment illustrated in FIGS. 2 and 3 is conventional, and that other conventional mechanisms may alternatively be used to actuate the brake assembly between the engaged and disengaged positions. For example, which should not be considered limiting in any way, the S-cam may be replaced by a conventional brake shoe actuator that converts the rotary motion of the cam shaft 16 to a linear motion that linearly controls the brake assembly 38 between the engaged and disengaged positions by linearly engaging at least one of the brake shoes 44A, 44B to engage and disengage the brake linings 46 with the inner surface 42 of the brake drum 40. As another example, which should not be considered to be limiting in any way, the S-cam may be replaced by a brake shoe actuator in the form of a wedge or other structure, and the cam shaft 16 may be configured to move linearly along its longitudinal axis rather than rotationally. In this example, the cam shaft 16 linearly actuates the wedge or other structure to control the brake assembly 38 between the engaged and disengaged positions. In this latter embodiment, it will be understood that the mechanism responsible for actuating the cam shaft to engage and disengage the brake assembly, one embodiment of which will be described hereinafter in relation to the illustrated embodiment, will typically be located at or near the end 16A of the cam shaft, or suitably located elsewhere relative to the cam shaft 16, such that the cam shaft actuating mechanism can move the cam shaft 16 in linear directions parallel to its longitudinal axis. It will also be understood that in this latter embodiment, the cam shaft movement sensor, one embodiment of which will be described hereinafter in relation to the illustrated embodiment, will be suitably located along the cam shaft 16 so that the sensor may produce a signal that is indicative of linear movement of the cam shaft 16 along its longitudinal axis. In any case, those skilled in the art will recognize other alternate structures and/or mechanisms for actuating the brake assembly between the engaged and disengaged positions based on the motion or movement of the cam shaft 16, and any such other alternate structures and/or mechanisms are contemplated by this disclosure. In this regard, the terms “move” and “movement” as used herein in relation to the operation of the cam shaft 16 will be understood to mean rotational and/or linear movement thereof unless otherwise specified.

Referring again to FIG. 1, the system 10 illustratively includes a conventional brake chamber 18 that is coupled to a conventional source of pressurized air (not shown) via an air passageway 20. The brake chamber 18 illustratively includes a diaphragm (not shown) or other conventional structure that is mechanically coupled to the cam shaft 16. Generally, the brake chamber 18 is responsive to air pressure supplied by the source of pressurized air to move the cam shaft 16 in a conventional manner. In the illustrated embodiment, the end 16B of the cam shaft 16 is configured such that rotation of the cam shaft 16 causes the brake assembly 38 to engage and disengage.

The system 10 further includes a conventional slack adjuster 90 that is illustratively coupled between the brake chamber 18 and the cam shaft 16. Generally, as brake linings 46 wear as a result of repeated applications of the brake 38, the cam shaft 16 in the illustrated embodiment must rotate further than when first installed to engage the brake linings 46 with the inner surface 42 of the brake drum 40. The slack adjuster 90 provides an adjustment mechanism that may be manually or automatically adjusted in a conventional manner to rotate the cam shaft 16 from its initial starting position, when the brake linings 46 were first installed, to an advanced starting position in order to compensate for the brake lining wear. Generally, the angle of the cam shaft 16 between the advanced starting position and the brake engaged position in which the brake linings 46 are forcibly engaged against the inner surface 42 of the brake drum 40 is shorter than the angle between the initial starting position and the brake engaged position. The slack adjuster 90 may be adjusted in this manner several times to advance the starting position further from the initial starting position and up to a maximum advanced position, as is known in the art.

The system further includes a cam shaft movement sensor 24 that is affixed to a support surface, e.g., to the axle 14, and that is configured to produce a signal that corresponds to the movement of the cam shaft 16 relative to a reference position. In embodiments in which the cam shaft 16 is configured to rotate, for example, the sensor 24 is a cam shaft angle sensor that is configured to produce a signal that corresponds to the angle of the cam shaft 16 relative to a reference angle. In embodiments in which the cam shaft 16 is configured to move linearly, as another example, the sensor 24 may be a position sensor that is configured to produce a signal that corresponds to the position of the cam shaft 16 relative to a reference position. In the illustrated embodiment, the angle sensor 24 is a non-contacting or “touchless” sensor having a sensor surface 24A that is positioned opposite to, but not in contact with, a magnetic surface 22A of the magnetic component 22 that is affixed to the end 16A of the cam shaft 16. The angle sensor 24 illustrated in FIG. 1 is, in the embodiment illustrated in FIG. 1, a wireless sensor that includes conventional signal transmission hardware that is configured to transmit or broadcast the sensor signals in the form of wireless signals in the radio frequency (RF) range. It will be understood, however, that this disclosure contemplates other embodiments of the sensor 24 that are configured to wirelessly transmit the sensor signals in one or more frequency ranges other than RF, embodiments of the sensor 24 that are not wireless but that are instead electrically connected to a signal monitor via one or signal wires, and/or embodiments of the sensor 24 that are in contact with, or coupled to, the end 16A of the cam shaft 16. In one specific embodiment, the angle sensor 24 is a CEX-2853-325 non-contact Rotary Position Sensor that is commercially available from Wabash Technologies, Inc. of Huntington, Ind.

The system 10 further includes a signal monitoring module 26 that is configured to receive the signals produced by the angle sensor 24. In the illustrated embodiment, the monitoring module 26 includes conventional signal receiving hardware that is configured to receive the wireless cam shaft angle signals 32 transmitted by the angle sensor 24, although the monitoring module 26 may alternatively be configured to be electrically connected to the angle sensor 24 via one or more signal wires 34 as shown by dashed-line representation in FIG. 1.

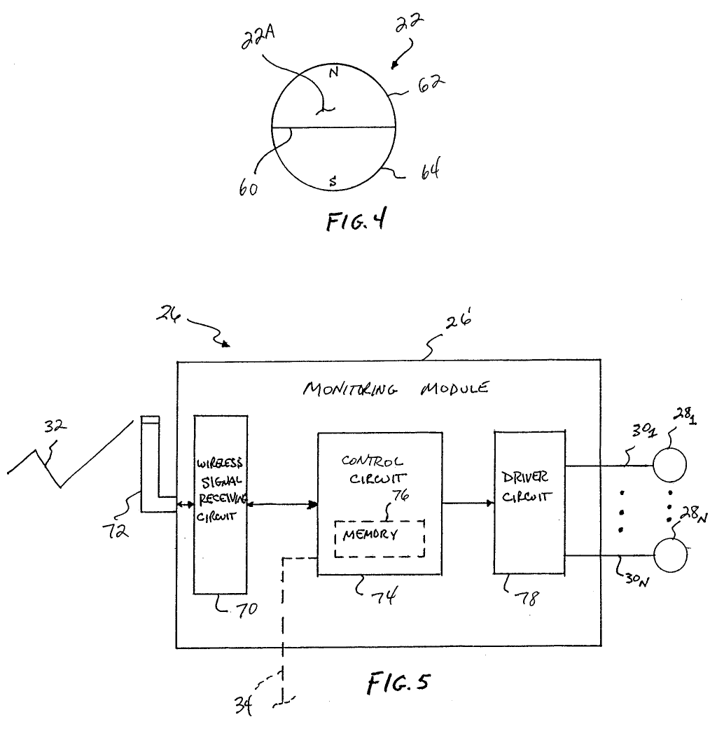

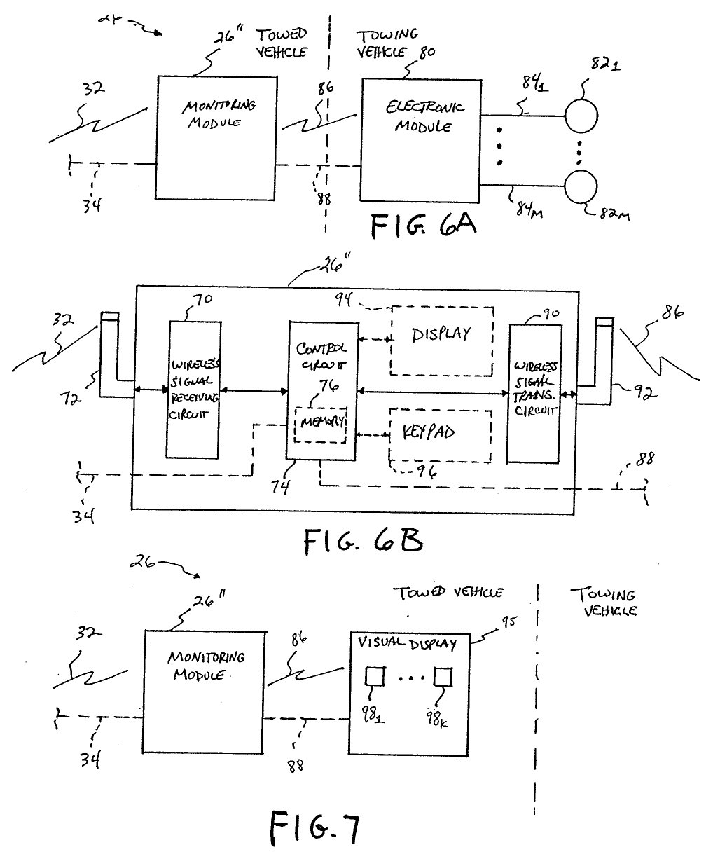

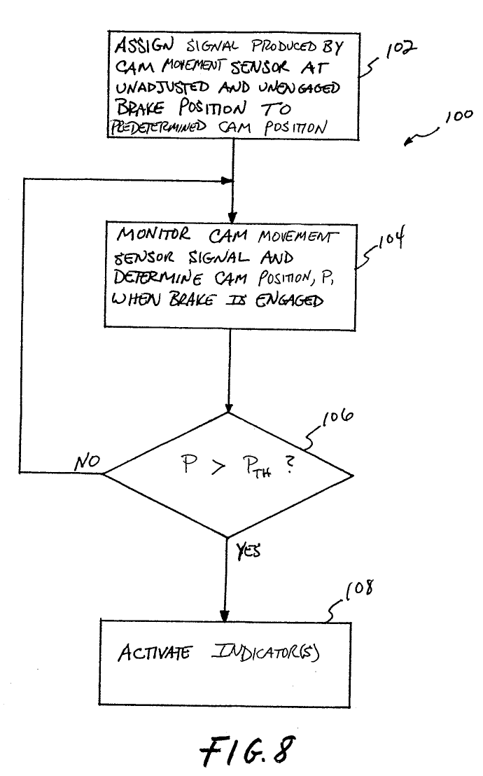

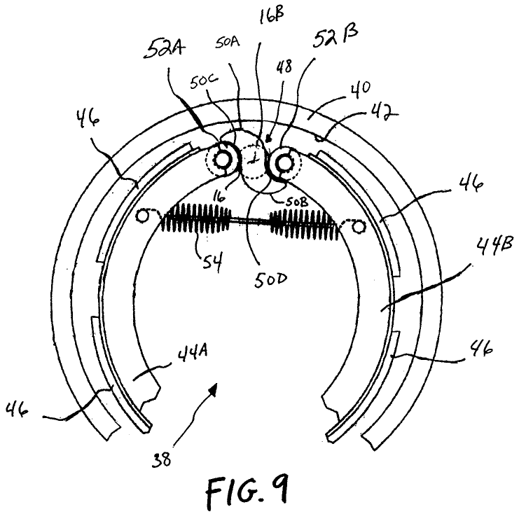

Referring now to FIG. 4, one illustrative embodiment of the magnetic surface 22A of the magnetic structure 22 is shown, as viewed through the section lines 4-4 of FIG. 1. In the illustrated embodiment, the magnetic surface 22A of the magnetic structure 22 is a circular structure that is bisected by a substantially planar interface 46, i.e., a straight line, into two pole regions 62 and 64. The pole region 62, in the illustrated embodiment, defines a magnetic north section, and the pole region 64 defines a magnetic south region, and the opposing edges of the pole regions 62 and 64 are illustratively planar. The pole regions 62 and 64 are, in the illustrated embodiment, substantially equal in shape and surface area so that each defines about 50% of the surface 22A, although this disclosure contemplates other embodiments of the surface 22A of the magnetic structure 22 that are not circular in cross-sectional area, that are not bisected by a substantially straight line 60 and/or in which the pole regions 62 and 64 are not substantially equal in shape and/or surface area.

In one embodiment, the signal monitoring module 26 is an electronic control module configured to control, at least in part, operation of an internal combustion engine, an electronically controlled transmission and/or other operation of the vehicle to which the wheel 12 is mounted. Alternatively, the signal monitoring module 26 may be a conventional dedicated or shared signal monitoring device or system. In any case, the signal monitoring module 26 may be located in a cab area of the vehicle, under hood, beneath the vehicle or otherwise attached to the vehicle, or mounted within or otherwise attached to a wheeled structure that is towed, or driven (i.e., pushed) by the vehicle.

Referring now to FIG. 5, one illustrative embodiment 26′ of the signal monitoring module 26 is shown. In the illustrated embodiment, the module 26′ includes a conventional wireless signal receiving circuit 70 that is electrically connected to an antenna 72 and also to a control circuit 74. The antenna 72 may be mounted externally to the module 26′, e.g., to a housing that carries the module 26′, or may alternatively be mounted within the module 26′. In any case, the wireless signal receiving circuit 70 and antenna 72 are configured to receive the wireless signals 32 transmitted by the angle sensor 24, to convert the wireless signals to electrical signals, and to provide the converted electrical signals to the control circuit 74 in a conventional manner.

The control circuit 74 has at least one input that is electrically connected to at least one corresponding output of the wireless signal receiving circuit 70. Alternatively, as shown by dashed-line representation, the control circuit 74 may have at least one input connected to the one or more signal wires 34 in embodiments in which the one or more signal wires 34 connect the sensor 24 to the monitoring module 26′. In any case, the control circuit 74 is configured to evaluate the converted electrical signals received from the wireless signal receiving circuit 70 or the electrical signals carried by the one or more signal wires 34 to determine whether the brake linings 46 associated with the wheel 12 are excessively worn and therefore in need of replacement. In one embodiment, the control circuit 74 is microprocessor-based, although the control circuit 74 may alternatively be or include one or more general purpose and/or application specific integrated circuits capable of operation as will be described in greater detail hereinafter. In any case, the control circuit 74 includes, or has access to, a memory unit 76. The memory unit 76 has instructions stored therein, e.g., in the form of one or more computer algorithms, that are executable by the control circuit 74 to evaluate the converted electrical signals received from the wireless signal receiving circuit 70 or the electrical signals carried by the one or more signal wires 34 to determine whether the brake linings 46 associated with the wheel 12 are excessively worn. Details relating to one illustrative embodiment of such an algorithm will be described in greater detail with respect to FIG. 8. In any case, the control circuit 74 includes at least one output that is electrically connected to at least one corresponding input of a conventional driver circuit 78. The driver circuit 78 has at least a number, N, of outputs that are each electrically connected to a corresponding one of a corresponding number, N, of indicators 28₁-28_{N} via a corresponding number of signal paths 30₁-30_{N}, where N may be any positive integer. The control circuit 74 is configured to control the statuses of the various indicators 28₁-28_{N}, by selectively providing control signals to the driver circuit 78 in a conventional manner to thereby provide notification of whether the brake linings 46 associated with the wheel 12 are excessively worn. In embodiments that include multiple wheels 12 and therefore multiple brake assemblies 38, the control circuit 74 is configured to control the statuses of the various indicators 28₁-28_{N} to not only provide notification of whether the brake linings 46 associated with any of the wheels 12 are excessively worn, but to further identify which one or more of the multiple wheels 12 that have brake linings 46 that are excessively worn.

The number of indicators 28₁-28_{N} may be or include one or more conventional visual indicators and/or one or more conventional audible indicators. Examples of visual indicators include, but are not limited to, one or more conventional illumination devices, e.g., lamp, light emitting diode (LED) or the like, a conventional display screen, e.g., liquid crystal display (LCD), vacuum fluorescent (VF) display, LED display, a conventional graphic display, e.g., graphic instrument cluster, or the like. Examples of audible indicators include, but are not limited to, one or more conventional buzzers, beepers or other tone generating devices that produce one or more tones that may be fixed or variable frequency, and/or that may be emitted once or in any sequence or pattern and/or that may be or include one or more pre-recorded or synthesized voice messages, or the like. In any case, the one or more indicators 28₁-28_{N} may be positioned in a suitable location that may be observed by an operator of the vehicle and/or by service personnel, e.g., in the cab area of the vehicle or other suitable location.

Referring now to FIG. 6A, a block diagram of another illustrative embodiment of the monitoring module 26 of FIG. 1 is shown. In the embodiment illustrated in FIG. 6A, the monitoring module 26 is configured to be implemented in a vehicle application that includes a towing vehicle and at least one towed vehicle, i.e., at least one vehicle that is towed by the towing vehicle. In this embodiment, the monitoring module 26 includes a monitoring module 26″ that is mounted to or otherwise carried by the towed vehicle and an electronic module 80 that is mounted to or otherwise carried by the towing vehicle. The monitoring module 26″ is similar to the monitoring module 26′ of FIG. 5 in that it is configured to receive the wireless sensor signals 32 or the sensor signals produced by the sensor 24 via the one or more signal wires 34, and it is also configured to supply information to the electronic module 80 via wireless signals 86 or via one or more signals wires 88 as shown by dashed-line representation in FIG. 6B. The electronic module 80 may be identical to the monitoring module 26′ illustrated in FIG. 5, and has at least a number, M, of outputs that are each electrically connected to a corresponding one of a corresponding number, M, of indicators 82₁-82_{M} via a corresponding number of signal paths 84₁-84_{M}, where M may be any positive integer. A control circuit within the electronic module 80 is configured to control the statuses of the various indicators 82₁-82_{M} by selectively providing control signals to a driver circuit that is electrically connected to the signal paths 84₁-84_{M}. The number of indicators 82₁-82_{M} may be or include one or more conventional visual indicators and/or one or more conventional audible indicators, examples of which were provided hereinabove with respect to FIG. 5, and any such number of indicators 82₁-82_{N} will generally be located on or within the towing vehicle such that the activation states of the various number of indicators 82₁-82_{N} can be readily observed by an occupant of the towing vehicle and/or service personnel that service the towing vehicle.

Referring now to FIG. 6B, a block diagram of one illustrative embodiment of the monitoring module 26″ of FIG. 6A is shown. The monitoring module 26″ is identical in several respects to the monitoring module 26′ illustrated in FIG. 5, and like numbers are therefore used to identify like components. The monitoring module 26″ differs from the monitoring module 26′ in that the monitoring module 26″ illustratively includes a conventional wireless signal transmission circuit 90 having at least one input that is electrically connected to the control circuit 74, and that has at least one output that is electrically connected to another antenna 92. The antenna 92 may be identical to the antenna 72 or may alternatively be different from the antenna 72 in size, shape and/or frequency range of operation. The control circuit 74 is configured in this embodiment to generate the wireless signals 86 via conventional control of the wireless signal transmission circuit 90. In one alternate embodiment, the wireless signal transmission circuit 90 and antenna 92 may be omitted, and the control circuit 74 may be electrically connected to a similar control circuit of the electronic module 80 via the one or more signal wires 88. In another alternate embodiment, the wireless signal transmission circuit 90 and antenna 92 may be omitted, the wireless signal receiving circuit 70 may be replaced with a conventional wireless signal transceiver circuit, and the wireless signal transceiver circuit 70 may be used in a conventional manner to receive the wireless signals 32 via the antenna 72 and to transmit the wireless signals 86 via the antenna 72.

The signal monitoring module 26″ may optionally include a conventional display device 94 that is electrically connected to the control circuit 74, as shown by dashed-line representation in FIG. 6B. The display device 94 may be any conventional display device, examples of which include, but are not limited to, a liquid crystal display (LCD), a vacuum fluorescent (VF) display, an LED display, a conventional graphic display, or the like. In this embodiment, the monitoring module 26″ may further optionally include a conventional keypad 96 that is electrically connected to the control circuit 74. The control circuit 74 is generally configured to control operation of the display device 94, and may further be responsive to manual operation of the keypad 96 to control the display device 94 to display selected data, to display one or more menus, to scroll information on the display 94, etc. in a conventional manner.

As with the monitoring module 26′ described above, the control circuit 74 of the monitoring module 26″ includes, or has access to, a memory unit 76. The memory unit 76 has instructions stored therein, e.g., in the form of one or more computer algorithms, that are executable by the control circuit 74 to process the converted electrical signals received from the wireless signal receiving circuit 70 or the electrical signals carried by the one or more signal wires 34. In one embodiment, for example, the control circuit 74 is operable to execute at least some of the instructions stored in the memory unit 76 to evaluate the signals produced by the sensor 24 and to determine therefrom whether the brake linings 46 associated with the wheel 12 are excessively worn, as described above. The control circuit 74 is then operable to execute other instructions stored in the memory unit 76 to transfer electrical signals to the electronic module 80, via the wireless signal transmission circuit 90 or via the one or more signal wires 88, which are indicative of whether the brake linings 46 associated with the wheel 12 are excessively worn. The electronic module 80 is then configured, as described hereinabove with respect to FIG. 5, to control the various indicators 82₁-82_{N}, to provide notification of whether the brake linings 46 associated with the wheel 12 are excessively worn and to also identify which one or more of the multiple wheels 12 that have brake linings 46 that are excessively worn. In embodiments of the monitoring module 26″ that include the display device 94, the electronic module 80 may be configured to only control the statuses of the various indicators 82₁-82_{N}, to provide notification of whether at least one of the wheels 12 has brake linings 46 that are excessively worn. The control circuit 74 is, in this embodiment, configured to control the display device 94 to identify which one or more of the wheels 12 that have brake linings 46 that are excessively worn.

In an alternate embodiment of the monitoring module 26 illustrated in FIGS. 6A and 6B, the control circuit 74 is operable to execute at least some of the instructions stored in the memory unit 76 to simply transfer the signals produced by the sensor 24 to the electronic module 80, via the wireless signal transmission circuit 90 or via the one or more signal wires 88. In this embodiment, the electronic module 80 is then configured, as described above, to evaluate the sensor signals to determine whether the brake linings 46 associated with any of the wheels 12 is/are excessively worn, and to then control the various indicators 82₁-82_{N}, to provide notification of not only whether the brake linings 46 associated with at least one of the wheels 12 are excessively worn, but to also identify which one or more of the multiple wheels 12 that have brake linings 46 that are excessively worn.

Referring now to FIG. 7, a block diagram of another illustrative embodiment of the monitoring module 26 of FIG. 1 is shown. In the embodiment illustrated in FIG. 7, as with the embodiment illustrated in 6A, the monitoring module 26 is configured to be implemented in a vehicle application that includes a towing vehicle and at least one towed vehicle, i.e., at least one vehicle that is towed by the towing vehicle. In this embodiment, the monitoring module 26 includes the monitoring module 26″ of FIG. 6B mounted to or otherwise carried by the towed vehicle and a visual display device 95 that is also mounted to or otherwise carried by the towed vehicle at a location that is viewable by an occupant of the towing vehicle. In the context of a heavy duty tractor truck towing one or more conventional trailers, for example, suitable locations for mounting the visual display device 95 may be either or both of the front corners of each trailer or only the trailer that is connected directly to the truck. Other suitable locations for mounting the visual display device 98 to one or more of the trailers will occur to those skilled in the art, and any such other acceptable locations are contemplated by this disclosure.

The monitoring module 26″ may be configured, as described above, to transmit wireless signals 86 to the visual display device 95, or to transfer electrical signals to the visual display device 95 via one or more conventional signal wires 88. In either case, the visual display device 95 includes a number, K, of visual display elements 98₁-98_{K}, where K may be any positive integer. The one or more visual display elements 98₁-98_{K} may be implemented in any conventional form, examples of which include, but are not limited to, one or more conventional lamps, one or more LED's, one or more conventional monitor screens, or the like.

The monitoring module 26″ is configured, as described hereinabove with respect to FIGS. 6A and 6B, to evaluate the signals produced by the sensor 24 to determine therefrom whether the brake linings 46 associated with one or more of the wheels 12 are excessively worn, and to then transfer wireless or other electrical signals to the visual display device 95 which are indicative of whether the brake linings 46 associated with one or more of the wheels 12 are excessively worn. In one embodiment, the control circuit 74 of the monitoring module 26″ is configured to control the visual display device 95 to selectively control operation of the one or more visual display elements 98₁-98_{K} in a manner that provides notification of whether the brake linings 46 associated with one or more of the wheels 12 are excessively worn and that also identifies which one or more of the multiple wheels 12 that have brake linings 46 that are excessively worn. In an alternate embodiment, the visual display device 95 may include conventional signal processing circuitry for evaluating the signals produced by the sensor 24 and controlling operation of the one or more visual display elements 98₁-98_{K} in a manner that provides notification of whether the brake linings 46 associated with one or more of the wheels 12 are excessively worn and that also identifies which one or more of the multiple wheels 12 that have brake linings 46 that are excessively worn. In this embodiment, the monitoring module 26″ is configured to simply pass the signals received from the sensor 24 to the visual display device 95. In another alternate embodiment, the control circuit 74 of the monitoring module 26″ is configured to control the visual display device 95 to selectively control operation of the one or more visual display elements 98₁-98_{K} in a manner that provides notification only of whether the brake linings 46 associated with at least one wheel 12 are excessively worn. In this embodiment, the monitoring module 26″ includes the display device 94, and the control circuit 74 is configured to control operation of the display device 94 in a manner that identifies which one or more of the multiple wheels 12 that have brake linings 46 that are excessively worn.

Referring now to FIG. 8, a flowchart is shown of one illustrative embodiment of a process 100 for monitoring brake wear. In the illustrated embodiment, the process 100 is provided in the form of software code that is stored in the memory unit 76 and executable by the control circuit 74 to monitor the signal produced by the cam shaft movement sensor 24, and to evaluate the cam shaft movement signal to determine whether the brake linings 46 are worn and in need of replacement. The process 100 begins at step 102 where the control circuit 74 is operable to assign the signal produced by the cam shaft movement sensor at an unadjusted and unengaged brake position to a reference cam shaft position. In embodiments in which the cam shaft 16 rotates to actuate the brake assembly 38, the reference cam shaft position may correspond to a predetermined cam shaft angle, such as zero degrees or some other negative or positive reference angle. In such embodiments in which the brake shoe actuator is a conventional S-cam as illustrated by example in FIGS. 2 and 3, the unadjusted and unengaged brake position corresponds to a predetermined position of the S-cam when replacement brake linings 46 are being installed as illustrated in FIG. 9. Referring to FIG. 9, the S-cam 48 defines concave surfaces 50C and 50D opposite to the convex surfaces 50A and 50B described above. When the brake assembly 38 is in the unadjusted and unengaged position illustrated in FIG. 9, the brake shoes 44A and 44B are drawn away from the surface 42 of the brake drum 40 under the bias of the spring 54 such that the wheel or roller 52A is positioned in contact with the concave surface 50C of the S-cam 48 and the wheel or roller 52B is positioned in contact with the concave surface 50D of the S-cam. Referring again to FIG. 8, the reference cam shaft position may alternatively correspond to a predetermined position of the cam shaft 16 in embodiments in which the cam shaft 16 moves linearly to actuate the brake assembly 38. Illustratively, step 102 may be carried out when the brake linings 46 are initially installed or replaced, as described above in embodiments that include a rotatable S-cam 48 as the brake shoe actuator, at which time the slack adjuster 90 is typically returned to its unadjusted position and the S-cam 48 is in the position illustrated in FIG. 9. Alternatively, such as in embodiments that include a linearly translating cam shaft 16, step 102 may be carried out at when the cam shaft 16 is in a predefined position with the slack adjuster 90 in its fully adjusted position. In either case, the control circuit 74 is operable at step 102 to assign the cam shaft position produced by the cam shaft movement sensor 24 to a reference cam shaft position value.

Following step 102, the control circuit 74 is operable at step 104 to monitor the cam shaft movement sensor signal, i.e., the signal produced by the cam shaft movement sensor 24, and determine a cam shaft position, P, when the brake assembly 38 is engaged. Illustratively, the control circuit 74 is operable to execute step 104 by continually monitoring the signal produced by the cam shaft movement sensor 24 and processing this signal to determine a maximum value of the cam shaft position, P. Generally, the maximum value of P will correspond to the position of the cam shaft 16 when the cam shaft 16 forces the brake linings 46 into engagement with the inner surface 42 of the brake drum 40, as illustrated in FIG. 3. With repeated engagements of the brake assembly 38, the brake linings 46 will abrade and the cam shaft position, P, will therefore advance overtime. In embodiments in which the cam shaft 16 is configured to rotate to engage the brake assembly 38, the cam shaft position, P, may be a cam shaft angle, θ, which corresponds to the maximum angle of the cam shaft when the cam shaft 16 forces the brake linings 46 into engagement with the inner surface 42 of the brake drum 40. Alternatively, in embodiments in which the cam shaft 16 is configured to move linearly to engage the brake assembly 38, the cam shaft position, P, may be a cam shaft position that corresponds to the position of the cam shaft 16 when the cam shaft 16 forces the brake linings 46 into engagement with the inner surface 42 of the brake drum 40.

Following step 104, the process 100 advances to step 106 where the control circuit 74 is operable to determine whether the cam shaft position, P, determined at step 104 is greater than a threshold position, P_{TH}. The threshold cam shaft position P_{TH} will typically be predetermined relative to the reference cam shaft position (step 102) and stored in the memory unit 76 prior to execution of the process 100. Illustratively, the threshold cam shaft position P_{TH} is a cam shaft position beyond which the brake assembly 38 is worn generally, and more specifically above which the brake linings 46 are worn. In one embodiment, for example, the threshold cam shaft position P_{TH} may correspond to a cam shaft position beyond which the brake linings are worn to the level that requires replacement. Alternatively, the threshold cam shaft position P_{TH} may correspond to a cam shaft position beyond which the brake linings are worn, but not yet to a level just prior that requires immediate replacement. Those skilled in the art will recognize other strategies for setting the threshold cam shaft position, P_{TH}, relative to the reference cam shaft position as it relates to the wear level of the brake linings 46, and any such other strategies are contemplated by this disclosure. In embodiments in which the cam shaft 16 is configured to rotate to engage the brake assembly 38, the threshold cam shaft position may be a threshold cam shaft angle, θ_{TH}, which corresponds to a cam shaft angle above which the brake linings 46 are worn as just described. In alternatively embodiments in which the cam shaft 16 is configured to translate linearly to engage the brake assembly 38, the threshold cam shaft position, P_{TH}, corresponds to a linear cam shaft position beyond which the brake linings 46 are worn as described.

Generally, the value of the threshold cam shaft position, P_{TH}, depends not only upon the wear level of the brake linings 46 as described above, but also on the value of the reference cam shaft position determined at step 102. In one illustrative embodiment in which the cam shaft 16 rotates, for example, the reference cam shaft position may be set to a reference cam shaft angle of zero degrees. The threshold cam shaft angle, θ_{TH}, in this case will then be the positive (or negative) cam shaft angle above which the brake assembly 38 is worn generally, and more specifically above which the brake linings 46 are worn. Alternatively, the reference cam shaft angle may be set to a fixed, positive or negative angle value. In this case, the threshold cam shaft angle, θ_{TH}, will then be the positive (or negative) cam shaft angle, offset by the difference between the reference cam shaft angle and zero degrees cam shaft angle, above which the brake assembly 38 is worn generally, and more specifically above which the brake linings 46 are worn. The same analysis applies in embodiments in which the cam shaft 16 translates linearly. In any case, the threshold cam shaft position, P_{TH}, and the reference cam shaft position will generally be determined prior to execution of the process 100, and the threshold cam shaft position, P_{TH}, and the reference cam shaft position will both be stored in the memory unit 76 prior to execution of the process 100.

If, at step 106, the control circuit 74 determines that the cam shaft position, P, at which the brake assembly 38 is engaged does not exceed the threshold cam shaft position, P_{TH}, the process 100 loops back to execute step 104. If, on the other hand, the control circuit 74 determines that the cam shaft position, P, at which the brake assembly 38 is engaged exceeds the threshold cam shaft position, P_{TH}, the process 100 advances to step 108 where the signal monitoring module 26 is operable to activate at least one of the indicators, as described with respect to any of FIGS. 5-7. The control circuit 74 thus continually executes steps 104 and 106 until a predefined level of brake wear is detected, after which at least one of the indicators is activated to notify an operator, occupant and/or service person of the worn brake condition.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A system for monitoring brake wear in a wheel of a transportation vehicle, comprising:
a brake assembly coupled to the wheel,
a cam shaft coupled to the brake assembly and configured such that movement of the cam shaft engages and disengages the brake assembly,
a cam shaft movement sensor configured to produce a signal corresponding to a position of the cam shaft,
at least one indicator, and
a control circuit including a memory having instructions stored therein that are executable by the control circuit to assign the signal produced by the cam shaft movement sensor at an unadjusted and unengaged position of the brake assembly to a reference cam shaft position, to thereafter monitor the signal to determine an engaged cam shaft position when the brake assembly is engaged, and to activate the at least one indicator if the engaged cam shaft position exceeds a threshold cam shaft position stored in the memory unit,
wherein the threshold cam shaft position is predetermined relative to the reference cam shaft position prior to storage in the memory unit, and is a cam shaft position beyond which the brake assembly is worn.

2. The system of claim 1 wherein the brake assembly comprises at least one brake lining mounted to at least one brake shoe within a brake drum,
and wherein the unadjusted and unengaged position of the brake assembly corresponds to an unengaged position of the brake when the at least one brake lining is initially installed on the at least one brake shoe.

3. The system of claim 2 wherein the brake assembly is engaged when the at least one brake lining is forced by the cam shaft against an inner surface of the brake drum,
and wherein the cam shaft position beyond which the brake assembly is worn is selected to be a cam shaft position beyond which the at least one brake lining is worn.

4. The system of claim 3 wherein the cam shaft is configured such that rotation of the cam shaft engages and disengages the brake assembly,
and wherein the cam shaft movement sensor is configured to produce a signal corresponding to an angle of the cam shaft,
and wherein the instructions stored in the memory are executable by the control circuit to assign the signal produced by the cam shaft movement sensor at the unadjusted and unengaged position of the brake assembly to a reference cam shaft angle, to thereafter monitor the signal to determine an engaged cam shaft angle when the brake assembly is engaged and to activate the at least one indicator if the engaged cam shaft angle exceeds a threshold cam shaft angle stored in the memory unit, and wherein the threshold cam shaft angle is a cam shaft angle above which the brake assembly is worn.

5. The system of claim 4 wherein the reference cam shaft angle is selected to be a fixed cam shaft angle of zero degrees.

6. The system of claim 4 wherein the reference cam shaft angle is selected to be a fixed, non-zero cam shaft angle.

7. The system of claim 3 wherein the cam shaft is configured such that linear translation of the cam shaft engages and disengages the brake assembly,
and wherein the cam shaft movement sensor is configured to produce a signal corresponding to linear movement of the cam shaft,
and wherein the instructions stored in the memory are executable by the control circuit to assign the signal produced by the cam shaft movement sensor at the unadjusted and unengaged position of the brake assembly to a reference cam shaft position, to thereafter monitor the signal to determine an engaged cam shaft position when the brake assembly is engaged and to activate the at least one indicator if the engaged cam shaft position exceeds a threshold cam shaft position stored in the memory unit,
and wherein the threshold cam shaft position is a cam shaft position beyond which the brake assembly is worn.

8. The system of claim 1 wherein the brake assembly comprises at least one brake lining mounted to at least one brake shoe within a brake drum and a slack adjuster that is responsive to adjustment thereof to bring the at least one brake lining closer to the brake drum,
and wherein the unadjusted and unengaged position of the brake assembly corresponds to an unengaged position of the brake when the slack adjuster is in an unadjusted position prior to any adjustment thereof.

9. The system of claim 8 wherein the brake assembly is engaged when the at least one brake lining is forced by the cam shaft against an inner surface of the brake drum,
and wherein the cam shaft position beyond which the brake assembly is worn is selected to be a cam shaft position beyond which the at least one brake lining is worn.

10. The system of claim 9 further comprising a brake shoe actuator mounted to one end of the cam shaft, the brake shoe actuator having at least one convex surface and at least one concave surface,
wherein the cam shaft is configured such that rotation of the cam shaft causes the at least one convex surface of the brake shoe actuator to engage the at least one brake shoe and move the brake assembly between engaged and disengaged positions,
and wherein the unadjusted and unengaged position of the brake assembly corresponds to a position of the cam shaft when the at least one concave surface of the brake shoe actuator engages the at least one brake shoe.

11. The system of claim 10 wherein the cam shaft movement sensor is configured to produce a signal corresponding to an angle of the cam shaft,
and wherein the instructions stored in the memory are executable by the control circuit to assign the signal produced by the cam shaft movement sensor at the unadjusted and unengaged position of the brake assembly to a reference cam shaft angle, to thereafter monitor the signal to determine an engaged cam shaft angle when the brake assembly is engaged and to activate the at least one indicator if the engaged cam shaft angle exceeds a threshold cam shaft angle stored in the memory unit,
and wherein the threshold cam shaft angle is a cam shaft angle above which the brake assembly is worn.

12. The system of claim 11 wherein the reference cam shaft angle is selected to be a fixed cam shaft angle of zero degrees.

13. The system of claim 11 wherein the reference cam shaft angle is selected to be a fixed, non-zero cam shaft angle.

14. The system of claim 9 wherein the cam shaft is configured such that linear translation of the cam shaft engages and disengages the brake assembly,
and wherein the cam shaft movement sensor is configured to produce a signal corresponding to linear movement of the cam shaft,
and wherein the instructions stored in the memory are executable by the control circuit to assign the signal produced by the cam shaft movement sensor at the unadjusted and unengaged position of the brake assembly to a reference cam shaft position, to thereafter monitor the signal to determine an engaged cam shaft position when the brake assembly is engaged and to activate the at least one indicator if the engaged cam shaft position exceeds a threshold cam shaft position stored in the memory unit,
and wherein the threshold cam shaft position is a cam shaft position beyond which the brake assembly is worn.

15. The system of claim 1 further comprising a magnetic component mounted to one end of the cam shaft,
and wherein the cam shaft movement sensor comprises a magnetic sensor.

16. The system of claim 15 wherein the cam shaft movement sensor comprises a magnetic sensor positioned relative to the magnetic component such that the magnetic sensor does not physically contact the magnetic component.

17. The system of claim 15 wherein the magnetic component comprises a magnetic surface having a portion that is formed of a magnetic north material and a separate portion that is formed of a magnetic south material.

18. The system of claim 17 wherein the portion of the magnetic surface that is formed of a magnetic north material comprises about 50% of the magnet, and the separate portion of the magnet that is formed of a magnetic south material comprises about another 50% of the magnet.

19. The system of claim 18 wherein opposing edges of the north and south materials of the magnetic surface are planar.

20. The system of claim 19 wherein the magnetic component is circular in cross-section.

21. The system of claim 15 wherein the magnetic sensor is a wireless sensor configured to transmit the signal wirelessly.

22. The system of claim 21 wherein the control circuit comprises a wireless signal receiving circuit configured to receive the signal wirelessly transmitted by the magnetic sensor.

23. The system of claim 15 further comprising a physical signal communication path electrically connected between the magnetic sensor and the control circuit.

24. The system of claim 1 wherein the cam shaft angle sensor is a wireless sensor configured to transmit the signal wirelessly.

25. The system of claim 1 further comprising a physical signal communication path electrically connected between the cam shaft movement sensor and the control circuit.

26. The system of claim 1 wherein the at least one indicator comprises at least one visual indicator.

27. The system of claim 1 wherein the at least one indicator comprises at least one audible indicator.

28. The system of claim 1 wherein the at least one indicator is located in a cab area of the vehicle.

29. The system of claim 1 wherein the transportation vehicle includes a plurality of wheels and a corresponding plurality of brake assemblies each coupled to a different one of the plurality of wheels,
and wherein the instructions stored in the memory include instructions that are executable by the control circuit to control the at least one indicator to provide notification when at least one of the plurality of brake assemblies is worn and to further identify which one or more of the brake assemblies is worn.

30. The system of claim 29 wherein the at least one indicator is located in a cab area of the vehicle.

31. The system of claim 29 wherein the vehicle comprises a towing vehicle and a towed vehicle that is towed by the towing vehicle,
and wherein the at least one indicator is located in a cab area of the towing vehicle.

32. The system of claim 29 wherein the vehicle comprises a towing vehicle and a towed vehicle that is towed by the towing vehicle,
and wherein the at least one indicator comprises at least one indicator located in the cab area of the vehicle and at least one indicator mounted to or carried by the towed vehicle.

33. The system of claim 32 wherein the at least one indicator located in the cab area of the vehicle is controlled only to provide notification when at least one of the plurality of brake assemblies is worn,
and wherein the at least one indicator carried by or mounted to the towed vehicle is controlled to identify which one or more of the brake assemblies is worn.

34. The system of claim 33 wherein the towing vehicle is a tractor truck and the towed vehicle comprises at least one trailer.

35. The system of claim 29 wherein the vehicle comprises a towing vehicle and a towed vehicle that is towed by the towing vehicle,
and wherein the at least one indicator comprises at least a first visual indicator mounted to or carried by the towed vehicle and at least a second visual indicator mounted to or carried by the towed vehicle at a location that is visible by an occupant of the towing vehicle.

36. The system of claim 35 wherein the at least a second visual indicator is controlled only to provide visual notification when at least one of the plurality of brake assemblies is worn,
and wherein the at least a first visual indicator is controlled to identify which one or more of the brake assemblies is worn.

37. The system of claim 36 wherein the towing vehicle is a tractor truck and the towed vehicle comprises at least one trailer.

38. The system of claim 1 wherein the brake assembly comprises at least one brake lining mounted to at least one brake shoe within a brake drum,
and further comprising an actuator mounted between the cam shaft and the at least one brake shoe, the actuator configured to be responsive to movement of the cam shaft to engage and disengage the brake assembly by moving the at least one brake shoe to correspondingly engage and disengage the at least one brake lining with an inner surface of the brake drum.

39. The system of claim 38 wherein the actuator is a rotatable actuator configured to be responsive to rotation of the cam shaft to rotatably engage the at least one brake shoe to engage and disengage the at least one brake lining with the inner surface of the brake drum.

40. The system of claim 38 wherein the actuator is a linear actuator configured to be responsive to rotation or linear movement of the cam shaft to linearly engage the at least one brake shoe to engage and disengage the at least one brake lining with the inner surface of the brake drum.

41. A method of monitoring brake wear of a brake assembly associated with a wheel of a transportation vehicle, the brake assembly having at least one brake lining coupled to a cam shaft configured such that movement of the cam shaft engages and disengages the brake assembly, and a cam shaft movement sensor configured to produce a signal corresponding to a position of the cam shaft, the method comprising:
assigning the signal produced by the cam shaft movement sensor at an unadjusted and unengaged position of the brake assembly to a reference cam shaft position,
monitoring the signal produced by the cam shaft movement sensor and determining a cam shaft position corresponding thereto when the brake assembly is engaged, and
activating at least one indicator if the cam shaft position exceeds a threshold cam shaft position that was predetermined relative to the reference cam shaft position and stored in a memory unit, the threshold cam shaft position corresponding to a cam shaft position beyond which the at least one brake lining is worn.

42. A system for monitoring brake wear in a plurality of wheels of a transportation vehicle comprising a towing vehicle and a towed vehicle that is towed by the towing vehicle, the system comprising:
a plurality of brake assemblies each coupled to a different one of the plurality of wheels,
a plurality of cam shafts each coupled to a different one of the plurality of brake assemblies and configured such that movement of the cam shaft engages and disengages the corresponding brake assembly,
a plurality of cam shaft movement sensors each configured to produce a signal corresponding to a position of a different one of the plurality of cam shafts,
at least a first visual indicator carried by or mounted to the towed vehicle,
at least a second visual indicator carried by or mounted to the towed vehicle at a location that is visible by an occupant of the towing vehicle, and
a control circuit including a memory having instructions stored therein that are executable by the control circuit to monitor the signals produced by the plurality of cam shaft movement sensors and to control operation of the at least a second visual indicator to provide visual notification when one or more of the plurality of brake assemblies is worn, and to control operation of the at least a first visual indicator to identify which one or more of the plurality of brake assemblies is worn.

43. The system of claim 42 wherein the towing vehicle is a tractor truck and the towed vehicle comprises at least one trailer.

44. A system for monitoring brake wear in a plurality of wheels of a transportation vehicle comprising a towing vehicle and a towed vehicle that is towed by the towing vehicle, the system comprising:
a plurality of brake assemblies each coupled to a different one of the plurality of wheels,
a plurality of cam shafts each coupled to a different one of the plurality of brake assemblies and configured such that movement of the cam shaft engages and disengages the corresponding brake assembly,
a plurality of cam shaft movement sensors each configured to produce a signal corresponding to a position of a different one of the plurality of cam shafts,
at least a first visual indicator carried by the towing vehicle,
at least a second visual indicator carried by or mounted to the towed vehicle, and
a control circuit including a memory having instructions stored therein that are executable by the control circuit to monitor the signals produced by the plurality of cam shaft movement sensors and to control operation of the at least a first visual indicator to provide visual notification when one or more of the plurality of brake assemblies is worn, and to control operation of the at least a second visual indicator to identify which one or more of the plurality of brake assemblies is worn.

45. The system of claim 44 wherein the towing vehicle is a tractor truck and the towed vehicle comprises at least one trailer.
